(19) United States
(12) Patent Application Publication
(10) Pub. No.: US 2024/0354550 A1
(43) Pub. Date: Oct. 24, 2024

(54) ADAPTATION OF TASK PERFORMABLE BY PRE-TRAINED MODEL INTO PARALLEL HARDWARE

(71) Applicant: Microsoft Technology Licensing, LLC, Redmond, WA (US)

(72) Inventors: Jorge Alexandre SILVA TAVARES, Munich (DE); Mayukh DAS, West Bangal (IN); Victor Jonas RUEHLE, Trumpington (GB); Vedula Venkata Srikant BHARADWAJ, Bellevue, WA (US)

(21) Appl. No.: 18/302,701

(22) Filed: Apr. 18, 2023

(51) Int. Cl. G06N 3/045

(52) U.S. Cl. CPC G06N 3/045

(57) ABSTRACT

The computer-assisted parallelization of a task capable of being accomplished by a pre-trained machine learning model. Multiple learner models are created by, for each of at least some of the parallel compute resources, selecting one or more characteristics of a learner model based on one or more characteristics of the corresponding compute resource on which the learner model is to run. The learner models are then taught. The teaching occurs such that the learner model is capable of generating a task result when given the task. At task time, the tasks results are then aggregated to generate an aggregated task result. The learner models are thus collectively tailored to run efficiently on the corresponding hardware.

### BACKGROUND

Artificial Intelligence (AI) is the use of computing models to perform tasks. Such tasks can be performed in response to the application of rules to data. However, one type of artificial intelligence is machine learning, in which the computing model learns how to do tasks based on encountering data. Deep neural networks are one example of machine learning. Neural networks are becoming more and more complex. Some conventional neural network models have on the order of billions of parameters distributed amongst many layers of transformer.

Ensemble models combine smaller individual models that each have many fewer parameters, and few numbers of layers as compared to the largest of models. Results from the weaker individual models can be aggregated through for example majority-wins or averaging to generate an aggregated result that can approach the accuracy of the larger model. This is particularly true if the individual models are trained with different parameters and/or training algorithms thereby forcing each of the individual models to arrive at their individual results using different models.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments described herein relate to the computer-assisted parallelization of a task capable of being accomplished by a pre-trained machine learning model so that the parallelization is adapted to hardware. Multiple learner models are created by, for each of at least some of the parallel compute resources, selecting one or more characteristics of a learner model based on one or more characteristics of the corresponding compute resource on which the learner model is to run. The learner models are then taught. The teaching occurs such that the learner model is capable of generating a task result when given the task. At task time, the tasks results are then aggregated to generate an aggregated task result.

Because the learner models are selected based on characteristics of the corresponding parallel compute resource on which the learner model is to run, the learner models each are tailored to run efficiently on the corresponding compute resource. Accordingly, a task that may be done well by a large pre-trained model can be performed on hardware in an efficient manner, taking perhaps even less time than the task would take on the larger pre-trained model, and with comparable accuracy.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 illustrates an environment in which the principles described herein may be practiced, in which a task is parallelized across multiple compute resources taking into account characterized the compute resources;

FIG. 2 illustrates a flowchart of a method for parallelizing a task capable of being accomplished by a pre-trained machine learning model, in accordance with the principles described herein;

FIG. 3 illustrates a flowchart of a method for creating and operating learner models;

FIG. 4 illustrates a flowchart of a method for creating a learner model by distillation, in accordance with the principles described herein;

FIG. 5 illustrates a flowchart of a method for creating a learner model by sparcification, in accordance with the principles described herein;

FIG. 6 illustrates a flowchart of a method for operating learner models in accordance with the principles described herein; and

FIG. 7 illustrates a basic configuration of a computing system.

### DETAILED DESCRIPTION

Embodiments described herein relate to the computer-assisted adaptation of hardware to parallelize a task capable of being accomplished by a pre-trained machine learning model. Multiple learner models are created by, for each of at least some of the parallel compute resources, selecting one or more characteristics of a learner model based on one or more characteristics of the corresponding compute resource on which the learner model is to run. The learner models are then taught. The teaching occurs such that the learner model is capable of generating a task result when given the task. At task time, the tasks results are then aggregated to generate an aggregated task result.

Because the learner models are selected based on characteristics of the corresponding parallel compute resource on which the learner model is to run, the learner models each are tailored to run efficiently on the corresponding compute resource. Accordingly, a task that may be done well by a large pre-trained machine learning model can be performed on hardware in an efficient manner, taking perhaps even less time than the task would take on the larger pre-trained model, and with comparable accuracy.

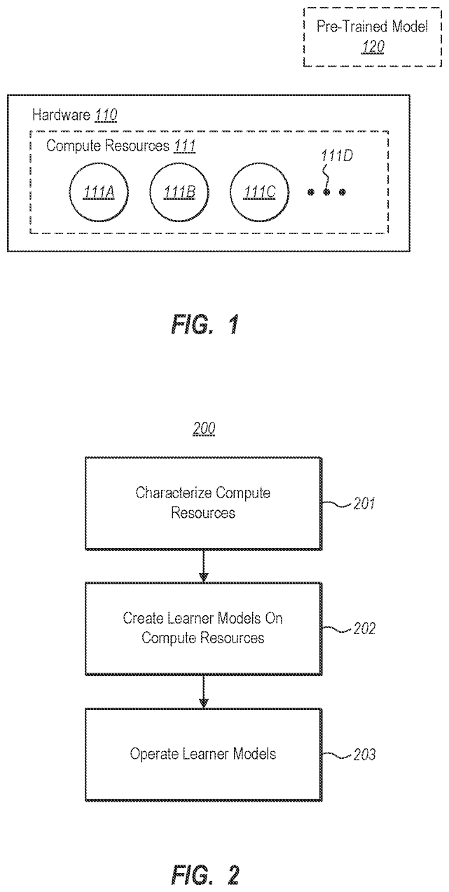

FIG. 1 illustrates an environment 100 in which the principles described herein may be practiced. The environment 100 includes hardware 110 that has multiple compute resources 111 that are each capable of performing a task in parallel. This task is a task that may be performed by a pre-trained machine learning model 120. However, the principles described herein allow the task to be performed by multiple smaller models across the parallel computer resources 111, instead of performing the task by the larger pre-trained machine learning model 120. Such may decrease the time it takes to perform the task as well as allow the task to be performed using the available hardware 110.

The principles described herein on not limited to what the task is. However, the task is some task that is capable of being performed by the larger machine learning model 120. An example of such a task could be a classification task in which input is classified. For instance, the classification might be to identify what is depicted in in image, the tone or topic of a writing, and so forth. As another example, the task could be a natural language task in which output is generated based on input text. For instance, such a task could be to generate a chat response based on chat input, to autocomplete natural language, or to generate code based on an instruction. However, these are merely examples of a task that may be performed by a larger machine learning model 120. Nevertheless, the principles described herein allow the hardware 110 to be adapted to instead perform the task taking into account the capabilities of the hardware 110 and its compute resources.

In the illustrated embodiment, the parallel compute resources 111 includes three compute resources 111A, 111B and 111C (symbolically represented as circles) that may execute the task in parallel. However, the ellipses 111D represent that the principles described herein may be practiced parallelize a task to any plural number of parallel compute resources.

The compute resources may be any physical or virtual resource that is capable of executing the task. As examples, a compute resource might be a processor core, a central processing unit, a graphical processing unit, a virtual machine, a compute node in a cloud computing environment, a compute cluster in a cloud computing environment, or any other resource capable of processing instructions. The compute resources 111 need not be the same type of compute resource as each other. As an example, one compute resource might be a virtual machine, and another might be a central processing unit. The hardware 110 may be a device or system, and may be a distributed system.

FIG. 2 illustrates a flowchart of a method 200 for a parallelizing a task capable of being accomplished by a pre-trained machine learning model, in accordance with the principles described herein. The method 200 may as an example be performed within the environment 100 of FIG. 1. Thus, for illustrative purposes only, the method 200 will be described while frequently referring back to the environment 100 of FIG. 1 by way of example.

The method 200 includes characterizing multiple parallel compute resources of hardware (act 201). Such characteristics may include resource-specific characteristics that help to define the capabilities of the compute resource. Such will be helpful in deciding the nature of models that may be efficiently deployed on the compute resource. For instance, a graphics processor unit may be specially adapted to efficiently perform certain types of computations that are performed by a particular type of model. Accordingly, the suitability of a compute resource to run a particular type of model may be ascertained by matching characteristics of the compute resource with characteristics of candidate models to run on the compute resource. The characteristic of the compute resource may also be model-specific and/or task-specific. For instance, the characteristic of a compute resource might include how long a task is estimated to be performed by a model if run on the compute resource.

The method 200 also includes creating learner models on the compute resources (act 202). For instance, a respective learner model may be selected for each of the compute resources and then created on the respective compute resource. For example, a first model may be deployed on the first compute resource 111A, a second model may be deployed on the second compute resource 111B, a third model may be deployed on the third compute resource 111C, and so forth. Each of the models has in common that the model is capable of performing the task capable of being performed by the pre-trained model. The learner models may be or include neural networks, may be or include decision trees, or may be any other model that is capable of learning.

The models that are to be deployed on each compute resources are much smaller than the pre-trained model 120. However, due to their size and special suitability for running on their respective compute resource, the task may be performed by each learner model more quickly as compared to the task being run on the pre-trained model 120. For instance, if the pre-trained model 120 includes a neural network with a certain number of transformer layers, the learner models that run on the compute resources may include a neural network with fewer transformer layers.

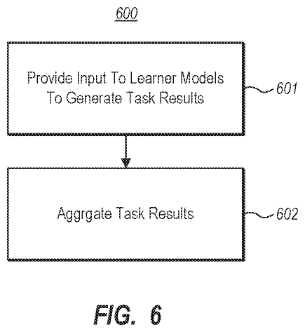

Nevertheless, because the models to be deployed on the compute resources are smaller, they may produce less accurate results as compared to the pre-trained model 120. Nevertheless, by aggregating the task results produced by each of the models into an aggregated result, the accuracy of the aggregated task result may approach the accuracy of the task result had the task run on the pre-trained model 120. Still, the aggregated task result can be obtained much more quickly and while using the hardware that is available. The method 200 also includes operating the learner models (act 203). An example of a method for operating will be described further below with respect to FIG. 6.

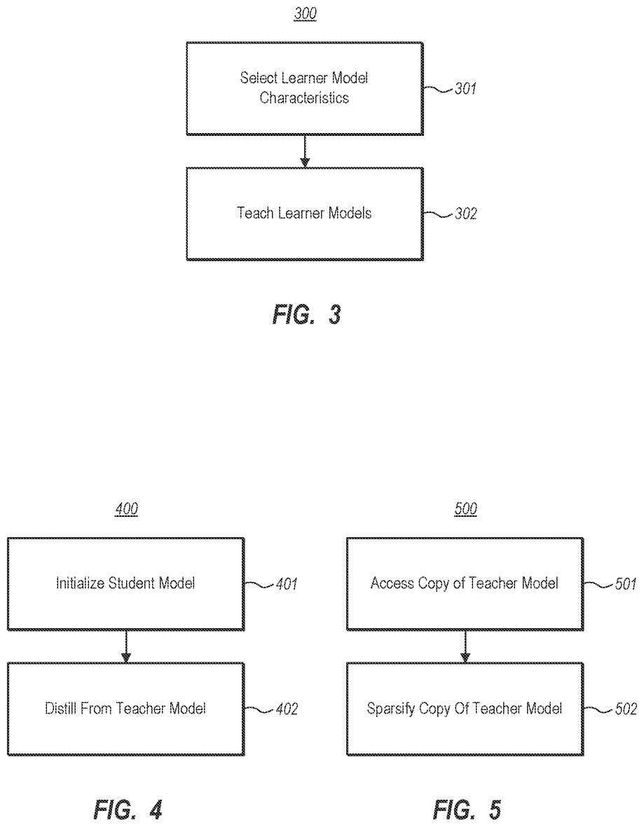

FIG. 3 illustrates a flowchart of a method 300 for creating and operating learner models. The method 300 includes selecting one or more characteristics of a learner model (act 301) based on one or more characteristics of the corresponding compute resource on which the learner model is to run, and then teaching the learner model (act 302). This process may occur in any fashion, but in several examples, the creation of the learner model may be performed by distillation and/or sparcification. For instance, a learner model may be created using both distillation and sparsification. Alternatively, or in addition, one learner model may be created by distillation, and another by sparsification.

FIG. 4 illustrates a flowchart of a method 400 for creating a learner model by distillation, in accordance with the principles described herein. In distillation, a learner model is created as a student model by initializing the student model (act 401), and applying distillation from a teacher model to tune the student model (act 402). Distillation techniques are known in the art. Distillation allows for the transfer of knowledge from a larger model (e.g., the pre-trained model 120) (also called a “teacher model”) to a smaller model (also called a “student model”) by using the teacher model as a guide. During the training process, the teacher model's output is used to provide additional supervision to the student model, the student model to learn with this additional supervision.

FIG. 5 illustrates a flowchart of a method 500 for creating a learner model by sparcification, in accordance with the principles described herein. Here, a copy of the teacher model is accessed (act 501), and then sparsification is applied to the teacher model (act 502). Sparcification is also a process that is known in the art. Sparsification involves reducing the number of parameters in a model, resulting in a sparcer and more efficient model.

FIG. 6 illustrates a flowchart of a method 600 for operating learner models in accordance with the principles described herein. In operation, the task input is provided to each learner model such that each leaner model generates a task result (act 601). The task results from each learner model are then aggregated (act 602) to generate an aggregated task result. Such aggregation may be any suitable aggregation including majority-voting, averaging, and others.

Accordingly, the principles described herein allow for parallelizing a task using smaller models and with faster results than might be obtained from a larger pre-trained model that performs the task, and in a manner that is adapted to the hardware available to perform the task. Thus, the principles described herein allow for reduced latency in performing a machine learning task, and also permits the task to be specially customized for performance by particular hardware.

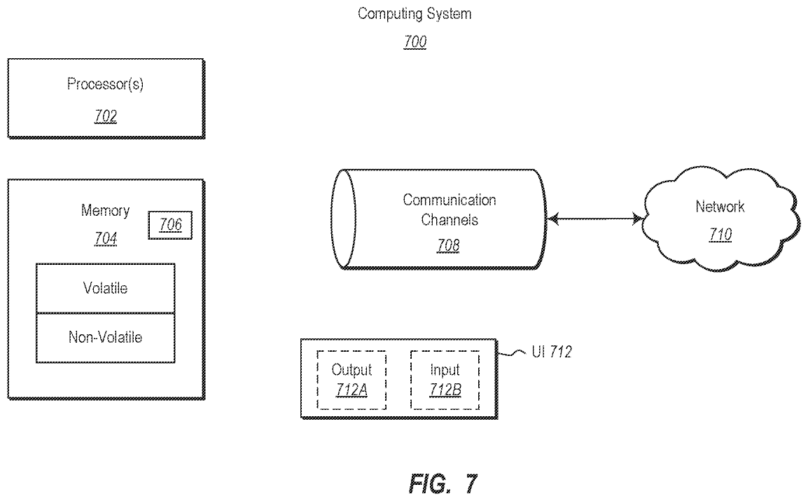

As illustrated in FIG. 7, in its most basic configuration, a computing system 700 includes at least one hardware processing unit 702 and memory 704. The processing unit 702 includes a general-purpose processor. Although not required, the processing unit 702 may also include a field programmable gate array (FPGA), an application specific integrated circuit (ASIC), or any other specialized circuit. In one embodiment, the memory 704 includes a physical system memory. That physical system memory may be volatile, non-volatile, processing-in-memory, or some combination thereof. In a second embodiment, the memory is non-volatile mass storage such as physical storage media. If the computing system is distributed, the processing, memory and/or storage capability may be distributed as well.

The computing system 700 also has thereon multiple structures often referred to as an “executable component”. For instance, the memory 704 of the computing system 700 is illustrated as including executable component 706. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods (and so forth) that may be executed on the computing system. Such an executable component exists in the heap of a computing system, in computer-readable storage media, or a combination.

One of ordinary skill in the art will recognize that the structure of the executable component exists on a computer-readable medium such that, when interpreted by one or more processors of a computing system (e.g., by a processor thread), the computing system is caused to perform a function. Such structure may be computer readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data. If such acts are implemented exclusively or near-exclusively in hardware, such as within a FPGA or an ASIC, the computer-executable instructions may be hard-coded or hard-wired logic gates. The computer-executable instructions (and the manipulated data) may be stored in the memory 704 of the computing system 700. Computing system 700 may also contain communication channels 708 that allow the computing system 700 to communicate with other computing systems over, for example, network 710.

While not all computing systems require a user interface, in some embodiments, the computing system 700 includes a user interface system 712 for use in interfacing with a user. The user interface system 712 may include output mechanisms 712A as well as input mechanisms 712B. The principles described herein are not limited to the precise output mechanisms 712A or input mechanisms 712B as such will depend on the nature of the device. However, output mechanisms 712A might include, for instance, speakers, displays, tactile output, virtual or augmented reality, holograms and so forth. Examples of input mechanisms 712B might include, for instance, microphones, touchscreens, virtual or augmented reality, holograms, cameras, keyboards, mouse or other pointer input, sensors of any type, and so forth.

Embodiments described herein may comprise or utilize a special-purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmission media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then be eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special-purpose computing system, or special-purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable compute resources (e.g., networks, servers, storage, applications, and services). The definition of “cloud computing” is not limited to any of the other numerous advantages that can be obtained from such a model when properly deployed.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

Clause 1. A computing system comprising: one or more processors; and one or more computer-readable media having thereon computer-executable instructions that are structured such, when executed by the one or more processors, the computing system would parallelize a task capable of being accomplished by a pre-trained machine learning model to adapt to hardware, such that the parallelization comprises: characterizing a plurality of parallel compute resources of the hardware; and creating and operating a plurality of learner models by, for each of at least some of the parallel compute resources, performing the following: selecting one or more characteristics of a learner model based on one or more characteristics of the corresponding compute resource on which the learner model is to run; teaching to the learner model; and providing input to the learner model so that the learner model generates a task result; and aggregating the task results from at least some of the at least some of the plurality of learner models to generate an aggregated task result.

Clause 2. The computing system in accordance with claim 1, the one or more characteristics of the learner model comprising a time estimate for the learner model to perform the task using the corresponding compute resource.

Clause 3. The computing system in accordance with claim 1, the creation being performed by for at least one of the plurality of learner models, creating the learner model as a student model by initializing the student model, and applying distillation from a teacher model to tune the student model.

Clause 4. The computing system in accordance with claim 3, the learner model being a first learner model, the creation being performed by for at least one of the plurality of learner models, creating the learner model as a second student model by sparcifying the teacher model to create the second student model.

Clause 5. The computing system in accordance with claim 1, the creation being performed by for at least one of the plurality of learner models, creating the learner model as a student model by sparcifying a teacher model to create the student model.

Clause 6. The computing system in accordance with claim 1, at least one of the plurality of learner models comprising a neural network.

Clause 7. The computing system in accordance with claim 7, the pre-trained machine learning model also being a neural network, a number of layers of the neural network of the learner model being less than a number of layers of the pre-trained machine learning model.

Clause 8. The computing system in accordance with claim 1, at least one of the plurality of learner models comprising a decision tree.

Clause 9. The computing system in accordance with claim 1, the task being a classification task in which input is classified.

Clause 10. The computing system in accordance with claim 1, the task being a natural language task in which output is generated based on input text.

Clause 11. The computing system in accordance with claim 1, at least one of the parallel compute resources being a processor core.

Clause 12. The computing system in accordance with claim 1, at least one of the parallel compute resources being a central processing unit.

Clause 13. The computing system in accordance with claim 1, at least one of the parallel compute resources being a graphical processing unit.

Clause 14. The computing system in accordance with claim 1, at least one of the parallel compute resources being a compute node.

Clause 15. The computing system in accordance with claim 1, at least one of the parallel compute resources being a compute cluster.

Clause 16. A method performed by a computing system to parallelize a task capable of being accomplished by a pre-trained machine learning model, the parallelization adapted to hardware the method comprising: characterizing a plurality of parallel compute resources of the hardware; and creating and operating a plurality of learner models by, for each of at least some of the parallel compute resources, performing the following: selecting one or more characteristics of a learner model based on one or more characteristics of the corresponding compute resource on which the learner model is to run; teaching to the learner model; and providing input to the learner model so that the learner model generates a task result; and aggregating the task results from at least some of the at least some of the plurality of learner models to generate an aggregated task result.

Clause 17. The method in accordance with claim 16, the creation being performed by for at least one of the plurality of learner models, creating the learner model as a student model by initializing the student model, and applying distillation from a teacher model to tune the student model.

Clause 18. The method in accordance with claim 16, the creation being performed by for at least one of the plurality of learner models, creating the learner model as a student model by sparcifying a teacher model to create the student model.

Clause 19. The method in accordance with claim 16, at least one of the plurality of learner models comprising a neural network, the pre-trained machine learning model also being a neural network, a number of layers of the neural network of the learner model being less than a number of layers of the pre-trained machine learning model.

Clause 20. A method performed by a computing system to parallelize a task capable of being accomplished by a pre-trained machine learning model, the parallelization adapted to hardware, the method comprising: characterizing a plurality of parallel compute resources of the hardware; and creating and operating a plurality of learner models by, for each of at least some of the parallel compute resources, performing the following: selecting one or more characteristics of a learner model based on one or more characteristics of the corresponding compute resource on which the learner model is to run; teaching to the learner model; and providing input to the learner model so that the learner model generates a task result; and aggregating the task results from at least some of the at least some of the plurality of learner models to generate an aggregated task result, the creation being performed by for at least one of the plurality of learner models, creating the learner model as a student model by initializing the student model, and applying distillation from a teacher model to tune the student model, the creation being performed by for at least another of the plurality of learner models, creating the learner model as a student model by sparcifying a teacher model to create the student model, at least one of the plurality of learner models comprising a neural network, the pre-trained machine learning model also being a neural network, a number of layers of the neural network of the learner model being less than a number of layers of the pre-trained machine learning model.

The present invention may be embodied in other specific forms without departing from its spirit or characteristics. The described embodiments are to be considered in all respects only as illustrative and not restrictive. The scope of the invention is, therefore, indicate by the appended claims rather than by the foregoing description. All changes which come within the meaning and range of equivalency of the claims are to be embraced within their scope.

What is claimed is:

1. A computing system comprising:
one or more processors; and
one or more computer-readable media having thereon computer-executable instructions that are structured such, when executed by the one or more processors, the computing system would parallelize a task capable of being accomplished by a pre-trained machine learning model, the parallelization performed in a manner that is adapted to hardware, such that the adaptation comprises:
characterizing a plurality of parallel compute resources of the hardware; and
creating and operating a plurality of learner models by, for each of at least some of the parallel compute resources, performing the following:
selecting one or more characteristics of a learner model based on one or more characteristics of the corresponding compute resource on which the learner model is to run;
teaching to the learner model; and
providing input to the learner model so that the learner model generates a task result; and
aggregating the task results from at least some of the at least some of the plurality of learner models to generate an aggregated task result.

2. The computing system in accordance with claim 1, the one or more characteristics of the learner model comprising a time estimate for the learner model to perform the task using the corresponding compute resource.

3. The computing system in accordance with claim 1, the creation being performed by for at least one of the plurality of learner models, creating the learner model as a student model by initializing the student model, and applying distillation from a teacher model to tune the student model.

4. The computing system in accordance with claim 3, the learner model being a first learner model, the creation being performed by for at least one of the plurality of learner models, creating the learner model as a second student model by sparcifying the teacher model to create the second student model.

5. The computing system in accordance with claim 1, the creation being performed by for at least one of the plurality of learner models, creating the learner model as a student model by sparcifying a teacher model to create the student model.

6. The computing system in accordance with claim 1, at least one of the plurality of learner models comprising a neural network.

7. The computing system in accordance with claim 6, the pre-trained machine learning model also being a neural network, a number of layers of the neural network of the learner model being less than a number of layers of the pre-trained machine learning model.

8. The computing system in accordance with claim 1, at least one of the plurality of learner models comprising a decision tree.

9. The computing system in accordance with claim 1, the task being a classification task in which input is classified.

10. The computing system in accordance with claim 1, the task being a natural language task in which output is generated based on input text.

11. The computing system in accordance with claim 1, at least one of the parallel compute resources being a processor core.

12. The computing system in accordance with claim 1, at least one of the parallel compute resources being a central processing unit.

13. The computing system in accordance with claim 1, at least one of the parallel compute resources being a graphical processing unit.

14. The computing system in accordance with claim 1, at least one of the parallel compute resources being a compute node.

15. The computing system in accordance with claim 1, at least one of the parallel compute resources being a compute cluster.

16. A method performed by a computing system to parallelize a task capable of being accomplished by a pre-trained machine learning model, the parallelization performed in a manner that is adapted to hardware, the method comprising:
characterizing a plurality of parallel compute resources of the hardware; and
creating and operating a plurality of learner models by, for each of at least some of the parallel compute resources, performing the following:
selecting one or more characteristics of a learner model based on one or more characteristics of the corresponding compute resource on which the learner model is to run;
teaching to the learner model; and
providing input to the learner model so that the learner model generates a task result; and
aggregating the task results from at least some of the at least some of the plurality of learner models to generate an aggregated task result.

17. The method in accordance with claim 16, the creation being performed by for at least one of the plurality of learner models, creating the learner model as a student model by initializing the student model, and applying distillation from a teacher model to tune the student model.

18. The method in accordance with claim 16, the creation being performed by for at least one of the plurality of learner models, creating the learner model as a student model by sparcifying a teacher model to create the student model.

19. The method in accordance with claim 16, at least one of the plurality of learner models comprising a neural network, the pre-trained machine learning model also being a neural network, a number of layers of the neural network of the learner model being less than a number of layers of the pre-trained machine learning model.

20. A method performed by a computing system to parallelize a task capable of being accomplished by a pre-trained machine learning model, the parallelization performed in a manner that is adapted to hardware the method comprising:
characterizing a plurality of parallel compute resources of the hardware; and
creating and operating a plurality of learner models by, for each of at least some of the parallel compute resources, performing the following:
selecting one or more characteristics of a learner model based on one or more characteristics of the corresponding compute resource on which the learner model is to run;
teaching to the learner model; and
providing input to the learner model so that the learner model generates a task result; and
aggregating the task results from at least some of the at least some of the plurality of learner models to generate an aggregated task result,
the creation being performed by for at least one of the plurality of learner models, creating the learner model as a student model by initializing the student model, and applying distillation from a teacher model to tune the student model,
the creation being performed by for at least another of the plurality of learner models, creating the learner model as a student model by sparcifying a teacher model to create the student model,
at least one of the plurality of learner models comprising a neural network, the pre-trained machine learning model also being a neural network, a number of layers of the neural network of the learner model being less than a number of layers of the pre-trained machine learning model.
